(19) United States
(12) Patent Application Publication
(10) Pub. No.: US 2005/0160640 A1
(43) Pub. Date: Jul. 28, 2005

(54) Erasable tray labels

(76) Inventor: James Scott Anderson, Atlanta, GA (US)

Correspondence Address: JAMES SCOTT ANDERSON, 1214 HILLWOOD COURT SE, ATLANTA, GA, 30316-2660, US

(21) Appl. No.: 10/663,498

(22) Filed: Sep. 16, 2003

Related U.S. Application Data
(60) Provisional application No. 60/411,482, filed on Sep. 16, 2002.

(51) Int. Cl. G09F 3/00

(52) U.S. Cl. 40/324

(57) ABSTRACT

Apparatuses, methods, and systems are disclosed for mounting an erasable label on a tray or container without adhesive. In one embodiment, a label assembly is disclosed having an erasable writing surface mounted upon a semi-rigid core having a slot sized and shaped to fit on a side wall of a container. The writing surface may include a pair of opposing erasable tablets mounted on opposing sides of the core. The writing surface may be constructed to receive temporary dry-erase ink, water-soluble ink, or magnetic labels. The markings may be protected from accidental erasure by an elongate projection or rim, a removable transparent film, or the like. A method of using a label assembly is also disclosed. This Abstract is provided to comply with the rules and submitted with the understanding that it will not be used to interpret or limit the scope or meaning of the claims.

### CROSS-REFERENCE TO RELATED APPLICATIONS

This application claims the benefit and priority of the U.S. Provisional Application bearing Ser. No. 60/411,482, filed Sep. 16, 2002, which is incorporated herein by reference in its entirety.

### BACKGROUND

1. Technical Field

The disclosure herein relates generally to the field of labels and labeling devices and, more particularly, to an erasable labeling system for mounting on the edge of a tray, bin, divider, container, or similar item.

2. Description of Related Art

Modern offices and homes are cluttered with ad hoc labels for desk trays, bins, drawers, cabinets, dividers, and other storage compartments. All kinds of personnel, from mail clerks to corporate executives, routinely use trays designated for items either incoming or outgoing, yet no suitable labeling system exists for making an attractive and durable label.

The ad hoc labels hurriedly improvised using a typewriter or by writing on an adhesive label almost never look professional and they are inherently temporary. Adhesive labels vary widely in appearance and look unsightly after a short time. Routine use of the tray or bin will eventually tear the paper or smudge the ink, for example, requiring constant updating or excessive taping, further contributing to the lack of professional appearance.

The contents of a tray or container often blocks the label from clear view. A label attached directly to an inner or outer wall of a container, for example, may be obscured when the contents are placed inside the container. In addition to being blocked by the contents, the label in this type of location is also vulnerable to rubbing and scraping by the contents, a condition that typically shortens the useful life of the label. A need exists for a durable label supported in a protected location.

Labels fashioned from whatever material is available at the time, without consideration of future applications, often need to be changed or updated later. A handwritten label with a person's name or a project name, for example, must be changed for a new person or project. Labels that have been taped or glued to a container must be removed, often leaving adhesive residue, or a new label must be applied to cover it. A need exists for a label that is easy to update or repair without sacrificing its professional appearance.

There is a need in the art for a system and apparatus for conveniently marking trays and compartments to create a professional, attractive, durable, and customizable label. There is a related need for a labeling system that can be easily changed when the contents of a tray or other compartment changes.

### SUMMARY

The following summary is not an extensive overview and is not intended to identify key or critical elements of the apparatuses, methods, systems, and the like or to delineate the scope of such elements. This Summary provides a conceptual introduction in a simplified form as a prelude to the more-detailed description that follows.

Certain illustrative apparatuses, methods, systems, and the like are described herein as examples in connection with the following description and the accompanying drawing figures. These examples represent but a few of the various ways in which the principles underlying the apparatuses, methods, systems, and the like may be employed and thus are intended to include equivalents. Other advantages and novel features may become apparent from the detailed description presented later, when considered in conjunction with the drawing figures.

The above and other needs are met by the present invention which, in one embodiment, provides apparatuses, methods, and systems for providing a temporary label supported by a semi-rigid core releasably mounted about an edge of a surface of a tray or container.

The examples described herein include a temporary labeling apparatus. The apparatus may include a writing surface for removably receiving indicia and a semi-rigid core supporting the writing surface, the core defining a slot positioned and sized to releasably receive an edge of a generally planar surface. The label assembly may be created such that the writing surface extends at least partially beyond the edge of the surface when the edge is received within the slot. The label assembly may also include an elongate projection extending lengthwise along the writing surface and rising in height generally perpendicular to the writing surface. The elongate projection may include straight or curved segments and may at least partially surround the writing surface. The generally planar surface may include a wall of an open container.

The writing surface may adhere to the core. The writing surface may include a front writing surface facing a first direction and a rear writing surface facing a second direction generally opposing the first direction. The core may also include a second slot, distinct from the slot, the second slot also positioned and sized to releasably receive the edge.

An area of the writing surface may bear permanent indicia. At least a portion of the writing surface includes a vinyl-coated writing surface for removably receiving water-soluble indicia. At least a portion of the writing surface includes a metallic core such that the writing surface is suitable for removably receiving magnetic indicia.

The label assembly may also include a generally transparent film releasably adhered to at least a portion of the writing surface.

In another aspect of the present invention, a method of releasably mounting an erasable label about an edge of a generally planar surface is disclosed. The method may include providing a writing surface to receive the label, the writing surface suitable for removably receiving indicia; mounting the writing surface to a semi-rigid core; forming a slot within the core, the slot positioned and sized to releasably receive the edge; and inserting the edge into the slot to a depth.

The method may also include adjusting the depth such that the writing surface extends at least partially beyond the edge.

Where the surface comprises a wall of an open container and the edge defines an upper plane, the method may also include adjusting the depth such that the writing surface extends at least partially above the upper plane.

The method may also include providing an elongate projection extending lengthwise along the writing surface and rising in height generally perpendicular to the writing surface. The step of providing such an elongate projection may further include providing straight or curved segments at least partially surrounding the writing surface.

The method may also include providing a second writing surface facing a direction generally opposing that of the writing surface.

The method may also include forming a second slot within the core, distinct from the slot, the second slot also positioned and sized to releasably receive the edge.

The method may also include printing permanent indicia upon an area of the writing surface. The method may also include providing a vinyl-coated writing surface to receive the label, the coated writing surface suitable for removably receiving water-soluble indicia. The method may also include providing a metallic core beneath the writing surface such that the writing surface is suitable for removably receiving a magnetic indicia.

The method may also include providing a releasably adhesive and generally transparent film sized and shaped to be placed upon at least a portion of the writing surface.

These and other objects, features, and advantages of the present invention will become apparent upon reading the following detailed description of an embodiment of the invention when taken in conjunction with the drawing and the appended claims.

### BRIEF DESCRIPTION OF THE DRAWING

The invention will be more readily understood by reference to the following description, taken with the accompanying drawing figures, in which:

FIG. 1 is a perspective illustration of a label assembly, according to one embodiment of the present invention.

FIG. 2 is a section view illustrating a label assembly positioned across an edge of a generally planar surface, according to one embodiment of the present invention.

FIG. 3 is a front view illustrating a label assembly, according to one embodiment of the present invention.

FIG. 4 is a perspective illustration of a label assembly, according to one embodiment of the present invention.

FIG. 5 is a perspective illustration of a label assembly positioned across an edge of a wall of an open container, according to one embodiment of the present invention.

### DETAILED DESCRIPTION

The subject matter of this application is related to that disclosed in the U.S. Provisional Application bearing Ser. No. 60/411,482, filed Sep. 16, 2002, which is incorporated herein by reference in its entirety.

1. Introduction

Exemplary apparatuses, methods, systems, and the like are now described with reference to the drawings, where like reference numerals are used to refer to like elements throughout the several views. In the following description, for purposes of explanation, numerous specific details are set forth in order to facilitate a thorough understanding of the apparatuses, methods, systems, and the like. It may be evident, however, that the apparatuses, methods, systems, and the like can be practiced without these specific details. In other instances, well-known structures and devices are shown in block diagram form in order to simplify the description.

Although the label assembly of the present invention is most often described herein as a label for the edge of a desk tray or basket, the present invention is well suited for a wide variety of applications. Potential applications include but are not limited to labeling food trays, picture frames, product bins and baskets, merchandise displayed in trays or boxes, mail totes, partitioned containers, hanging file folders or file dividers, shelves, equipment, office cubicles or partition walls, and any object having a suitable edge upon which a label assembly may be positioned. The label assembly is generally suitable for use in any setting or environment where there is a need for a labeling system that can be easily changed when the contents of a tray or other container changes.

Furthermore, to the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (for example, A or B) it is intended to mean “A or B or both.” When the author intends to indicate “only A or B but not both,” the author will employ the phrase “A or B but not both.” Thus, use of the term “or” herein is inclusive, not exclusive. See Gamer, A Dictionary Of Modem Legal Usage 624 (2d ed. 1995).

Many modifications and other embodiments may come to mind to one skilled in the art who has the benefit of the teachings presented in the description and drawings. It should be understood, therefore, that the invention is not be limited to the specific embodiments disclosed and that modifications and alternative embodiments are intended to be included within the scope of the disclosure and the exemplary inventive concepts. Although specific terms may be used herein, they are used in a generic and descriptive sense only and not for purposes of limitation.

2. A Label Assembly

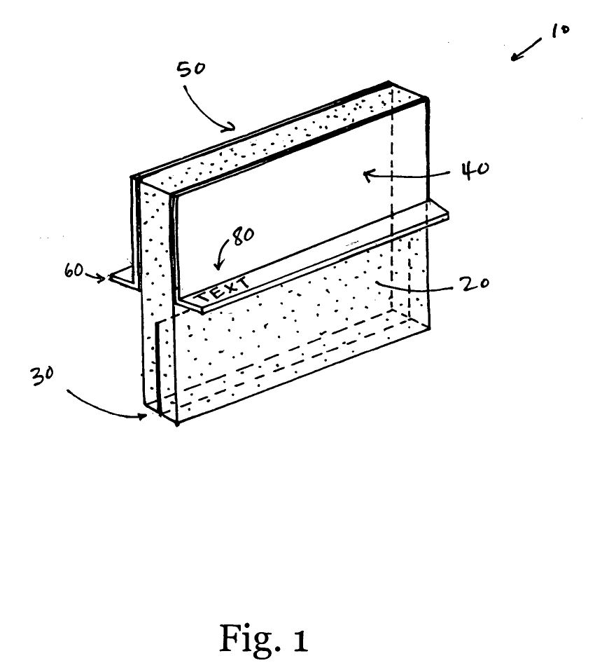

FIG. 1 illustrates a label assembly 10 according to one embodiment of the present invention. The label assembly 10 may include a writing surface 40 mounted upon a flexible core 20 in which a slot 30 may be provided. One or more writing surfaces or tablets 40, 50 may be provided. The term tablet as used herein refers to a generally flat slab or sheet used as a writing surface. In one embodiment, however, a portion of the tablet may or may not be suitable for use as a writing surface; that is, a portion of the tablet may support imprinted indicia 80, markings, or other features not suited for receiving marks from a writing instrument.

The writing surfaces or tablets 40, 50 may be made of a material commonly known as whiteboard or dry-erase board, suitable for marking by a writing instrument such as a semi-permanent dry-erase marker. The core 20 may be made of semi-rigid foam rubber or other material having both flexibility and resiliency. The slot 30 in the core 20 may be sized and shaped to fit snugly around the edge of a container or other object to be labeled, such that the label assembly 10 is stable and supported without adhesive or other fastening means. The lack of adhesive allows the label assembly 10 to be transferred to another container or repeatedly mounted on a container with ease. In this aspect, the slot's grasp on a surface is releasable and, accordingly, the slot 30 may be described herein as sized and shaped to ‘releasably receive’ a surface or edge of a container.

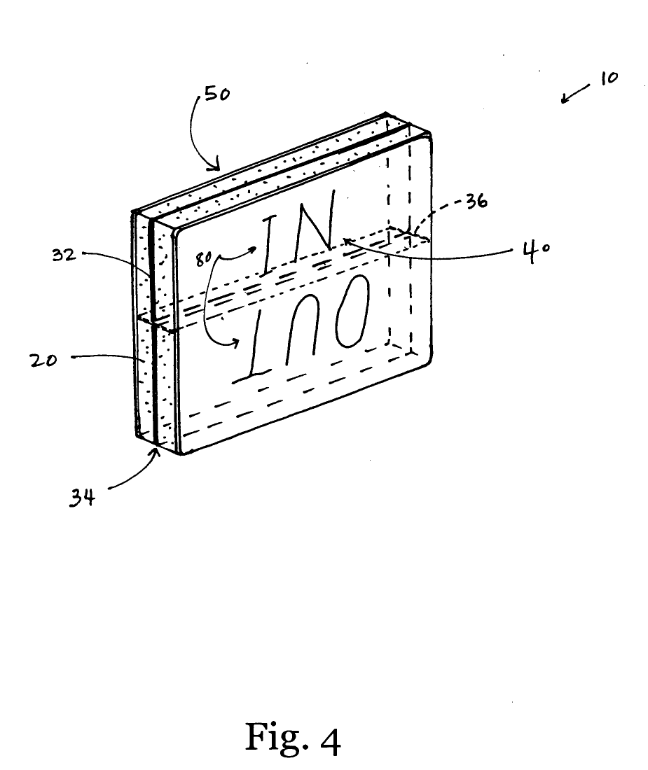

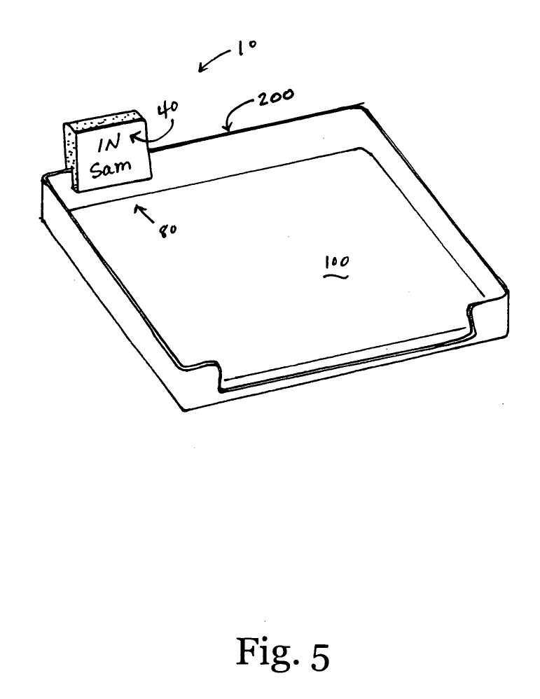

The writing surfaces or tablets 40, 50 may cover an entire side of the core 20 as shown in FIGS. 4 and 5, or only a portion of the core 20 as shown in FIGS. 1, 2, and 3.

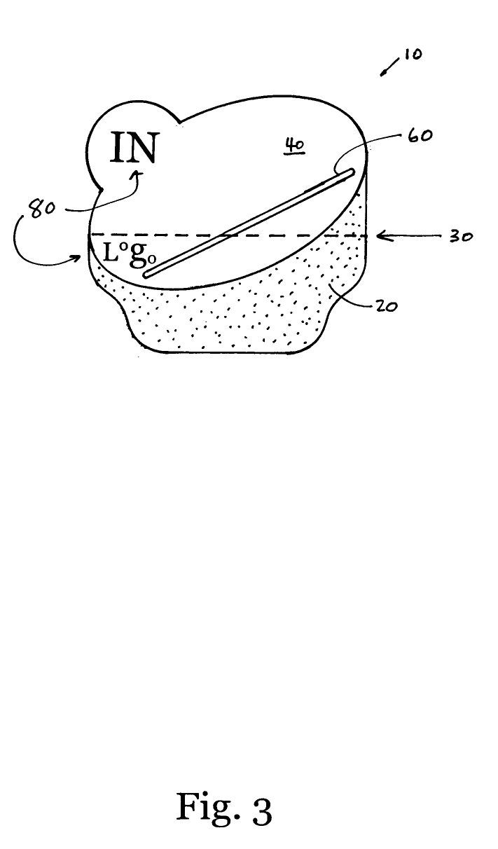

The label assembly 10 and its components may take different shapes, regular or irregular (as shown in FIG. 3), including rectangular, square, circular, oval, ovoid, or any other shape suited to a particular purpose.

2.1. The Writing Surfaces

Referring again to FIG. 1, the label assembly 10 may include one or more writing surfaces, such as a front tablet 40 and a rear tablet 50. The core 20 may support several tablets in different positions. The tablets 40, 50 may be fastened to the core 20 using a durable adhesive or other fastener. The tablets 40, 50 may or may not include a rim 60.

The rim 60, if present, may also be used as a writing surface 40 and/or a place for imprinted indicia 80 such as the “Text” shown in FIG. 1. In use, the label assembly 10 may be placed on a side of a tray or container located generally below the eye level of the user, such as on a desk. In this typical position, the rim 60 provides an ideal, upwardly-facing writing surface 40 or platform for imprinted indicia 80. In this aspect, the label assembly 10 may provide two or more writing surfaces 40 for communicating a variety of information to the user.

Providing both a front and rear tablet 40, 50 allows the user to mark either side or both sides of the label assembly 10, such that the text or other signage placed on the label assembly 10 may be viewed from either direction.

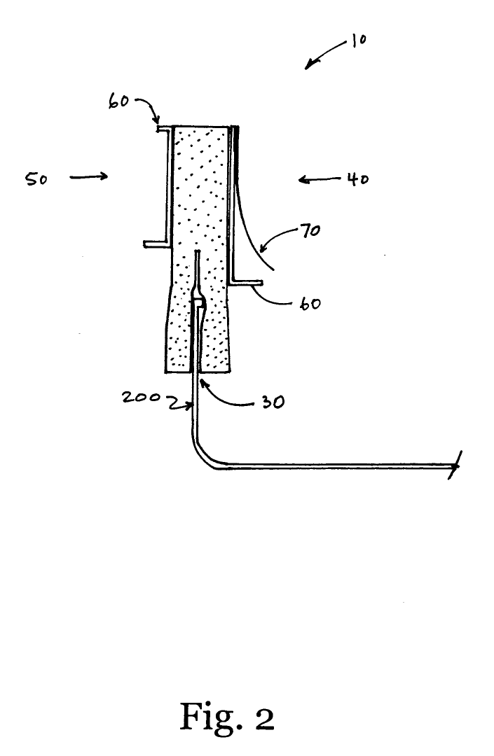

The tablets 40, 50 used for a particular label assembly 10 need not be the same size and shape. In use, providing tablets 40, 50 having different shapes and features (as shown in FIG. 2) may be advantageous or desired in a particular setting.

In one embodiment, the tablets 40, 50 are constructed of a material commonly known as whiteboard or dry-erase board, suitable for marking by semi-permanent dry-erase markers. The tablet material may be melamine or another laminate over a wooden board. Dry-erase board and markers is generally known and available. The writing surface of the present invention may receive temporary or semi-permanent markings or indicia from a writing instrument such as a dry-erase marker or pen. The temporary nature of the indicia may also be referred to by describing the writing surface as ‘removably receiving indicia.’

In another embodiment, the tablets 40, 50 may be constructed of vinyl-coated material capable of holding water-soluble ink and resisting smears and smudges. Vinyl coatings suitable for receiving water-soluble ink may be used to provide a label that may be somewhat more resistant to erasure than dry-erase ink. As the name implies, erasure of water-soluble ink may require the application of water to the markings or indicia, whereas dry-erase ink may not require water.

In yet another embodiment, the material for the tablets 40, 50 may be porcelain or another coating over a steel or metallic magnetic surface. In this alternative embodiment, a set of standard text massages on magnetic labels may be provided for removable application to on the magnetic surface. For example, a magnetic label imprinted with INCOMING MAIL or IN could be placed on a portion of the front tablet 40.

The tablets 40, 50 may be blank or they may include an imprinted message 80 that may be desired, such as the following examples, to name just a few: Filing, To Do, Requests, In (as shown in FIG. 3), Out, Purchase Orders, Incoming Mail, Outgoing Mail, Express Mail, UPS Next Day Air@, Interoffice Mail, Hand Deliver, Smith Project, Jones Case, and the like. The tablets 40, 50 may also include an imprinted indicia 80 such as a business name, trademark, or logo; for example, the stylized “Logo” shown in FIG. 3.

In one embodiment, the tablets 40, 50 may contain any combination of imprinted indicia 80 (words or marks) and writing surfaces of the various types described herein, as well as other types of writing surfaces suitable for use in this context. For example, the tablets 40, 50 may contain an imprinted message, logo, trademark, or other indicia 80, a blank space for receiving a handwritten message, and other space as well. In this aspect, the term writing surface may be used herein to describe a space for receiving either handwritten text or other types of indicia. As described above, the tablets 40, 50 may be constructed to receive dry-erase markings, water-soluble ink markings, magnetic labels, or other types of generally temporary indicia, in different areas. Any variety of combinations and shapes, such as the example illustrated in FIG. 3, may be created to perform a desired function or present a desired appearance. The text shown in FIG. 5, for example, may be handwriting on a non-magnetic melamine laminate. For the alternative magnetic embodiment, however, the text IN could be provided on a pre-printed magnetic label and adhered to the upper (or lower) portion of the front tablet 40; and the text “Sam” or any other custom message could be added by hand.

By providing space for custom messages on either or both tablets 40, 50, the label assembly 10 provides the user with the ability to prepare a uniform set of label assemblies 10 for use throughout an organization. All the bins in the warehouse, or all the trays in an office, for example, may be uniform in size and shape, while uniquely customized at each particular location or desk. By providing the alternative use of pre-printed text messages and/or magnetic labels, the user may add a custom logo, trademark, or business name to each of the label assemblies 10 in the set.

In this aspect, the surface of the tablets 40, 50 may be produced in a variety of colors, including wood grain or metallic finishes, to create a professional and uniform appearance throughout an entire location. The company logo and its trademark colors, for example, may be used to create a uniform look, while allowing for customization at each location.

The label assembly 10 of the present invention may be part of a labeling kit. A kit might include one or more label assemblies 10 of different or similar shapes and sizes, a series of magnetic signs sized and shaped to fit in a portion of the tablets 40, 50, a set of dry-erase markers in various colors and/or sizes, and a felt eraser. In this aspect, a labeling kit may be composed of a set designed for a particular office or location. For example, a kit may be assembled to meet the needs of a six-person office having a mail room and a copy center, with the appropriate pre-printed and customizable label assemblies 10 in the variety of shapes and sizes that might be needed in a typical office of that size and staff.

The label assembly 10 of the present invention may also be sized to hold a variety of messages. The label assembly 10 shown in FIG. 5 may span a relatively short portion of the length of the tray 100; however, a longer label assembly 10 may be used to provide space for more text on the tablets 40, 50. The name of a person or a department or project, for example, could be placed on a longer label assembly 10 having larger tablets 40, 50.

Likewise, a shorter or smaller label assembly 10 could also be used for different applications, such as supply bins where space for a single digit is desired. In a warehouse environment, for example, a large number of label assemblies 10 may be required to label very small bins containing small items; anything from hardware fasteners to microchips. The semi-rigid flexibility of the core 20 and the easy portability provided by the slot make the label assembly 10 ideal for environments where moving the label assemblies 10 may be desired.

2.2. The Core

The core 20 may be fashioned from a material that is flexible enough to receive an object (such as the edge of a desk tray) into the slot 30, but also rigid and resilient enough to firmly grasp the object without adhesive to provide stability for the label assembly 10. The core 20 may be sized and shaped such that the label assembly 10 may be mounted across an edge of a surface 200, as shown in FIG. 2, without the use of adhesive or other fasteners.

Two factors affecting the resiliency of the core 20 are the material selected and the size of the slot 30. In one embodiment, the core material and the slot size are selected such that the label assembly 10 resists unintended or accidental movement during normal use.

Flexibility may be desirable for the core 20, particularly in uses where the label assembly 10 may be intended for receiving a variety of surfaces having different shapes and sizes. As shown in FIG. 2, the core 20 may be sufficiently flexible to receive an edge of a generally planar surface 200 that includes an irregular shape. As shown, the upper edge of the surface 200 includes a projection or rim, which may require the core 20 to be particularly flexible. The surface 200 is described as generally planar because it may include such features or other irregularities.

The core 20 may be sized and shaped to receive a surface 200 having any thickness or shape. Similarly, the slot 30 may be sized and shaped to receive a surface 200 having any thickness or shape. The sectional view in FIG. 2 demonstrates the flexibility and resiliency of a core 20 according to one embodiment of the present invention.

By providing a semi-rigid core 20, the label assembly 10 can be attached temporarily to a variety of objects and surfaces without adhesive. The label assembly 10 may be easily transferred to another surface or container without leaving an adhesive residue.

Durability may be a desirable characteristic of the material selected for the core 20, to allow repeated uses (such as attaching, positioning, transferring) without the label assembly 10 losing its gripping ability. In use, a label assembly 10 may be removed and/or re-positioned often, such as when changing the message on the tablets 40, 50. Semi-rigid rubber processed or foamed to a suitable density may be readily available for this type of application.

In one embodiment, a material may be selected having sufficient density to withstand the forces exerted during writing or erasure of the tablet 40, 50 while the label assembly 10 remains positioned on the object. In other words, the user may write or erase markings without removing the label assembly 10 from the surface 200.

FIG. 5 illustrates a label assembly 10 mounted across an edge of a generally planar side wall or surface 200 of a typical desk tray 100. As shown, the edge of the surface 200 has been inserted into the slot 30 such that the label assembly 10 rests at a height at least partially above the upper edge of the surface 200. In this embodiment, at least a portion of the writing surface 40 is positioned above the area where the contents of the tray 100 or other container may accumulate. This positioning of the label assembly 10 may prevent inadvertent erasure by preventing or reducing the probability or frequency of contact between the writing surface 40 and the papers or other objects within the tray 100 or other container.

2.3. The Slot

The slot 30 in the core 20 may be sized and shaped according to the intended object or objects to be labeled. A typical plastic desk tray, for example, may require a slot 30 having a sufficient open width to receive the generally planar surface or wall of the tray within the slot 30, as shown in FIG. 2. In other applications, such as a thin-walled container or a wire basket, the slot 30 may have a generally narrow or zero open width. For other uses, such as a thick-walled partition or an irregularly shaped container, the slot 30 may have a large open width. The slot 30 in one embodiment need not be rectangular; that is, the slot 30 may include regions of various sizes having different shapes in cross-section to receive a particular surface 200. The slot 30 generally may be sized and shaped to receive a surface 200 of an object to be labeled, while providing stability and maintaining durability over a lifetime of use.

The slot 30 may or may not be centrally disposed with respect to the thickness of the core 20. Off-center positioning may be preferred for particular uses. In one aspect, the overall shape of the label assembly 10 may be considered when locating the slot 30 such that the entire label assembly 10 is generally balanced when a surface 200 is inserted into the slot 30.

In one embodiment, the slot 30 may be curved to receive the curvilinear edge of a cylindrical container such as an open canister or a paint can. The label assembly 10 and its component parts may or may not be curved to follow the contour of the object to be labeled. In one embodiment, the label assembly 10 may be generally straight and linear, with a curved slot 30 to receive a cylindrical edge. This kind of application represents just one of the possible uses of the present invention in different contexts.

FIG. 4 illustrates a label assembly 10 in one embodiment of the present invention. The label assembly 10 in this embodiment may be fastened to an object using an upper slot 32 or a lower slot 34. In this configuration, the label assembly 10 may be reversible about a generally horizontal plane. In use, the upper half of the tablet 40 may include a first text message, whereas the lower half of the tablet 40 may include a second text message. By providing dual messaging capability, the text massage on a tray or bin can be changed simply and immediately. In general, the upper slot 32 and lower slot 34 may remain separate, with a section of the core 20 remaining in place to separate the two slots. In one alternative, the core 20 may include a barrier or plate 36 between the slots 32, 34 to provide stability. A plate 36 may provide stability and durability between the slots 32, 34 by helping the assembly 10 withstand the stress of repeated uses.

2.4. The Rim

To prevent accidental erasure or smudging of the text, the tablet 40 may include a raised rim 60. In one embodiment, as shown in FIG. 1, the rim 60 may be positioned along an edge of the tablets 40,50 like a ledge. The rim 60 in this embodiment prevents the contents of the tray or container from resting or rubbing against the surface of the tablets 40, 50. In this aspect, the rim 60 helps prevent inadvertent erasure. The rim 60 may include multiple segments that are spaced apart or otherwise discontinuous.

In another embodiment, the rim 60 may surround all sides of the tablet 40 like a frame. As shown in FIG. 2, the rim 60 need not be the same on both tablets 40, 50. The rim 60 for the rear tablet 50 may be shaped like an upper ledge and a lower ledge. The rim 60 for the front tablet 60 may be shaped like a lower ledge only. The rim 60 shown in FIG. 3 is positioned at an angle, not along an edge of the tablet 40. In this aspect, the rim 60 may be used to alter or make unique the appearance of the overall label assembly 10 by framing or otherwise highlighting the message.

In general, the rim 60 of the present invention may be shaped like an elongate 20 projection extending lengthwise along the writing surface or tablet 40. The rim 60 may extend for a height in a direction that is generally perpendicular to the writing surface 40. The rim 60 need not be rectangular in shape and may extend at non-perpendicular angles relative to the writing surface 40. The rim 60 may include a series of straight or curved segments, connected or spaced apart, positioned in any location around the writing surface 40.

The rim 60 may be sized and shaped to act as a writing surface 40 and/or a place for receiving imprinted indicia 80, as shown in FIG. 1.

Alternatively or in addition to the rim 60, the label assembly 10 may include a transparent film 70 (as shown in FIG. 2) sized to fit over all or at least a portion of the writing surface 40 to protect the text and further prevent accidental erasure. The film 70 may be releasably adhesive, such that it provides temporary protection. The film 70 may be hinged or fastened along one edge of the tablet 40 or otherwise fastened temporarily to the tablet 40. In one embodiment, the film 70 is fastened by static forces alone, such that no adhesive is required to keep the film 70 in place temporarily.

3. Method

In another aspect, the present invention includes a method of releasably mounting an erasable label assembly 10 as disclosed herein upon a generally planar surface 200 as illustrated in FIG. 2 and FIG. 5. The method may include providing an erasable writing surface 40 mounted upon a semi-rigid core 20 having a slot 30 therein which is positioned and sized to releasably receive an edge of the surface 200 to a depth such that the label assembly 10 is supported without the use of an adhesive or other fastening means. The depth of insertion may be adjusted such that said writing surface 40 extends at least partially beyond or above the surface 200.

In one embodiment, the present invention provides a method of mounting an erasable label assembly 10 such that the writing surface 40 is located at least partially above a container. In this position, the erasable text may be readily viewed and may be protected from accidental erasure by the movement of contents within the container or tray 100. As illustrated in FIG. 5, for example, a portion of the writing surface 40 is located above the side walls of the tray 100, such that when the tray is filled to the top of the side walls, the contents do not obscure from view that portion of the writing surface 40. As contents are added or removed from the tray 100, that portion of the writing surface 40 positioned above the tray are somewhat protected from accidental erasure or smudging. The method of positioning the label assembly 10 at a height above the tray 100 or other container provides improved visibility and durability of the text on the writing surface 40.

The method may also include providing multiple slots 30 in the core 20 to facilitate mounting of the label assembly 10 in different configurations, as illustrated in FIG. 4. In one embodiment, the label assembly 10 may be mounted to an object using an upper slot 32 or a lower slot 34. In this configuration, the label assembly 10 may be reversible about a generally horizontal plane. By providing dual messaging capability, the text massage on a tray or bin can be changed simply and immediately.

The method may also include printing permanent indicia 80 upon an area of said writing surface 40 or upon the rim 60, as illustrated in FIG. 1. The markings may be protected by the rim 60 and/or by a providing a releasably adhesive and generally transparent film sized and shaped to be placed upon at least a portion of the writing surface 40.

4. Conclusion

The described embodiments of the invention are intended to be merely exemplary. Numerous variations and modifications will be apparent to those skilled in the art. All such variations and modifications are intended to fall within the scope of the present invention as defined in the appended claims.

What has been described above includes several examples. It is, of course, not possible to describe every conceivable combination of components or methodologies for purposes of describing the systems, methods, computer readable media and so on employed in planning routes. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

While the systems, methods, and apparatuses herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, the invention, in its broader aspects, is not limited to the specific details, the representative systems and methods, or illustrative examples shown and described. Accordingly, departures may be made from such details without departing from the spirit or scope of the applicant's general inventive concepts.

1. A label assembly comprising:
a generally planar writing surface for receiving temporary and permanent indicia; and
a semi-rigid core supporting said writing surface, said core defining a slot positioned and sized to releasably receive an edge of a generally planar wall of an open container such that a majority of said writing surface extends beyond said edge when said edge is received within said slot, and wherein the orientation of said slot is generally parallel to said writing surface.

2. The label assembly of claim 1, wherein at least a portion of said writing surface includes a whiteboard for removably receiving dry-erase indicia.

3. (canceled)

4. The label assembly of claim 1, further comprising an elongate projection extending lengthwise along said writing surface and extending in a lateral direction generally perpendicular to said writing surfaces, said projection sized and shaped to prevent inadvertent erasure of said temporary indicia.

5. The label assembly of claim 4, wherein said elongate projection is sized and shaped to act as a second writing surface.

6. The label assembly of claim 4, wherein said elongate projection bears permanent indicia.

7. The label assembly of claim 4, wherein said elongate projection includes one or more straight or curved segments at least partially surrounding said writing surface.

8. (canceled)

9. (canceled)

10. The label assembly of claim 1, wherein said writing surface comprises a front writing surface facing a first direction and a rear writing surface facing a second direction generally opposing said first direction.

11. The label assembly of claim 1, wherein said core further defines a second slot, distinct from said slot, said second slot also positioned and sized to releasably receive said edge such that a majority of said writing surface extends beyond said edge when said edge is received within said slot, and wherein the orientation of said slot is generally parallel to said writing surface.

12. The label assembly of claim 1, wherein an area of said writing surface bears permanent indicia.

13. The label assembly of claim 1, wherein at least a portion of said writing surface includes a vinyl-coated writing surface for removably receiving water-soluble indicia.

14. The label assembly of claim 1, wherein at least a portion of said writing surface includes a metallic core such that said writing surface is suitable for removably receiving magnetic indicia.

15. The label assembly of claim 1, further comprising a generally transparent film releasably adhered to at least a portion of said writing surface.

16. A method of releasably mounting an erasable label across an edge of a generally planar wall of an open container, said method comprising:
providing a generally planar writing surface to receive said label, said writing surface suitable for receiving temporary and permanent indicia;
mounting said writing surface to a semi-rigid core; and
forming a slot within said core, said slot positioned and sized to releasably receive said edge such that a majority of said writing surface extends beyond said edge when said edge is received within said slot, and wherein the orientation of said slot is generally parallel to said writing surface.

17. The method of claim 16, wherein said step of providing a writing surface further comprises:
providing a whiteboard to receive said label, said whiteboard suitable for removably receiving dry-erase indicia.

18. (canceled)

19. (canceled)

20. The method of claim 16, further comprising:
providing an elongate projection extending lengthwise along said writing surface and extending in a lateral direction generally perpendicular to said writing surface, said projection sized and shaped to prevent inadvertent erasure of said temporary indicia.

21. The method of claim 20, wherein said step of providing an elongate projection further comprises:
sizing and shaping said elongate projection for use as a second writing surface.

22. The method of claim 20, wherein said step of providing an elongate projection further comprises:
arranging one or more straight or curved segments of said elongate projection to at least partially surround said writing surface.

23. The method of claim 16, further comprising:
providing a second writing surface facing a direction generally opposing that of said writing surface.

24. The method of claim 16, further comprising:
forming a second slot within said core, distinct from said slot, said second slot also positioned and sized to releasably receive said edge such that a majority of said writing surface extends beyond said edge when said edge is received within said slot, and wherein the orientation of said slot is generally parallel to said writing surface.

25. The method of claim 16, further comprising
printing permanent indicia upon an area of said writing surface.

26. The method of claim 16, further comprising wherein said step of providing a writing surface further comprises:
providing a vinyl-coated writing surface to receive said label, said coated writing surface suitable for removably receiving water-soluble indicia.

27. The method of claim 16, further comprising:
providing a metallic core beneath said writing surface such that said writing surface is suitable for removably receiving a magnetic indicia.

28. The method of claim 16, further comprising:
providing a releasably adhesive and generally transparent film sized and shaped to be placed upon at least a portion of said writing surface.
